(19) United States
(12) Patent Application Publication
(10) Pub. No.: US 2005/0277709 A1
(43) Pub. Date: Dec. 15, 2005

(54) Polymer layers having infrared absorbing particles

(76) Inventor: William Keith Fisher, Suffield, CT (US)

Correspondence Address: BRENC LAW, 47 BANKS ROAD, SIMSBURY, CT, 06070, US

(21) Appl. No.: 10/855,415

(22) Filed: May 28, 2004

(51) Int. Cl. B32B 27/42; B32B 27/02; C08K 9/10

(52) U.S. Cl. 523/210; 428/323; 428/331; 428/328; 428/426; 428/437; 428/327

(57) ABSTRACT

The present invention is in the field of polymer sheets and multiple layer glass panels comprising light absorbing agents, and, more specifically, the present invention is in the field of polymer sheets and multiple layer glass panels comprising agents that selectively absorb infrared, and specifically, near infrared radiation.

### FIELD OF THE INVENTION

The present invention is in the field of polymer sheets and multiple layer glass panels comprising light absorbing agents, and, more specifically, the present invention is in the field of polymer sheets and multiple layer glass panels comprising agents that selectively absorb infrared, and specifically, near infrared radiation.

### BACKGROUND

Poly(vinyl butyral) (PVB) is commonly used in the manufacture of polymer sheets that can be used as interlayers in light-transmitting laminates such as safety glass or polymeric laminates. Safety glass often refers to a transparent laminate comprising a poly(vinyl butyral) sheet disposed between two sheets of glass. Safety glass often is used to provide a transparent barrier in architectural and automotive openings. Its main function is to absorb energy, such as that caused by a blow from an object, without allowing penetration through the opening or the dispersion of shards of glass, thus minimizing damage or injury to the objects or persons within an enclosed area. Safety glass also can be used to provide other beneficial effects, such as to attenuate acoustic noise, reduce UV and/or IR light transmission, and/or enhance the appearance and aesthetic appeal of window openings.

In many architectural applications it is desirable to use safety glass that not only has the proper physical performance characteristics for the chosen application, but also has light transmission characteristics that are particularly suitable to the end use of the product. For example, it will often be desirable to limit infrared radiation transmission through laminated safety glass in order to provide improved thermal properties.

The ability to reduce transmission of infrared radiation, and specifically near infrared radiation, can be a particularly desirable characteristic of multiple layer glass, and particularly for safety glass that is used in automotive and architectural applications. Reducing the transmission of infrared radiation can result in the reduction of heat generated by such radiation within an enclosed space.

Many examples exist in the art of compositions and methods to reduce infrared radiation transmission through multiple layer glass panels. Many of these, however, require modification of basic fabrication techniques, addition of layers to the final multiple layer product, or incorporation of agents that are expensive or block desirable visible light as well as infrared radiation.

Further improved compositions and methods are needed to enhance the characteristics of multiple layer glass panels, and specifically multiple layer glass panels comprising poly(vinyl butyral) layers, so as to impart desirable optical patterns and light transmission and reflectance qualities on the finished glass panel.

### SUMMARY OF THE INVENTION

The present invention includes infrared absorbing agents, polymeric sheets comprising those agents, and various multiple layer glass constructs that comprise those polymeric sheets. Agents of the present invention include those having a dielectric core disposed within a conductive coating that selectively absorb infrared radiation.

The present invention includes a polymer interlayer comprising an infrared absorbing agent, wherein said agent comprises a dielectric core disposed within a conductive coating.

The present invention includes a multiple layer glass panel comprising a polymer interlayer comprising an infrared absorbing agent, wherein said agent comprises a dielectric core disposed within a conductive coating.

The present invention includes a method for reducing transmission of infrared radiation through an opening, comprising: disposing in said opening a multiple layer glass panel comprising a polymer interlayer comprising an infrared absorbing agent, wherein said agent comprises a dielectric core disposed within a conductive coating.

### BRIEF DESCRIPTION OF THE FIGURES

FIG. 1 represents a schematic illustration of a single agent particle having a dielectric core disposed within a conductive coating.

### DETAILED DESCRIPTION

The present invention involves infrared absorbing agents and their use in multiple layer glass panels that can be used, for example, in automotive windshields and architectural applications. As disclosed herein, particles that comprise a dielectric-type inner particle that has been coated with a conductive-type material can result in an agent that selectively absorbs light in the infrared region of the electromagnetic spectrum. As used herein, an agent that “selectively absorbs” light in a particular region of wavelengths means that the agent significantly absorbs light in that particular region without also greatly absorbing light in other regions of the spectrum. This result is useful in automotive and architectural type applications because it is usually desirable to allow the transmission of visible light through a multiple layer glass panel while concomitantly limiting, through absorption or otherwise, the amount of infrared radiation that is transmitted.

Previous attempts in the art to reduce infrared radiation include using conductive particles or nanoparticles disposed within a polymer sheet interlayer. These particles, however, may not be sufficiently selective in the radiation range desired.

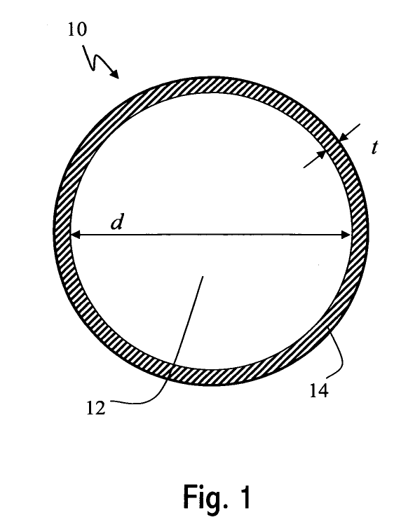

The present invention includes an infrared absorbing agent comprising a dielectric core disposed within a conductive coating, which together will be described herein as a “dielectric core/conductive coating agent” to distinguish the agents of the present invention from conventional infrared absorbing agents. As shown generally at 10, in FIG. 1, which is a schematic representation of a cross section of one embodiment of the agent of the present invention, a dielectric core 12 is disposed within a conductive coating 14. The dielectric core 12 can be approximately spherical in shape, but it can also be non-spherical, for example, ovoid or irregularly spherical.

Dielectric Core

In various embodiments, the dielectric core can be less than 1,000 nanometers (nm), less than 750 nanometers, less than 500 nanometers, less than 300 nanometers, less than 200 nanometers, less than 100 nanometers, or less than 75 nanometers across its widest dimension, which, for the spherical embodiment shown in FIG. 1, is represented as “d”. In various embodiments in which the agents of the present invention are used within a polymer sheet, the dielectric core can be any of the above widths or less at its widest point for at least 80%, 90%, 95%, 99%, or 100% of all of the individual particles in the polymer sheet. That is, in some embodiments, most or almost all of the particles will fall within the given range, and some will be larger than the given range. It will be understood by those in the art that the size of the dielectric core and the thickness of the conductive coating, as well as the selection of materials, can be determined so as to suit the application and desired wavelength absorption.

The dielectric core can comprise any composition that has sufficient electrical insulating character. The dielectric core can comprise any composition that can be formed into the appropriately sized and shaped particle, and that is compatible with the chosen electrically conductive coating. Examples of compositions that can be used include, but are not limited to, titanium dioxide, silica, gold sulfide, polymethyl methacrylate, colloidal silica, benzoguanimine, and polystyrene. In some embodiments, the dielectric core comprises colloidal silica. In various embodiments, the dielectric core has a resistivity of at least 10¹⁴ S/cm.

The dielectric cores of the present invention can be manufactured by any conventional methods, as are known in the art (see, for example, Stober, W., et al. J. Colloid Interface Sci. 26:62 (1968)).

Conductive Coating

According to the present invention, the conductive coating, shown as 14 in FIG. 1, can comprise any suitable conductive composition, including, but not limited to, copper, silver, gold, platinum, palladium, iridium, nickel, antimony tin oxide, indium tin oxide, and alloys and mixtures of the foregoing. In some embodiments, the conductive coating comprises silver, gold, or copper. In general, a conductive coating material will be selected that is compatible with the dielectric core and any polymeric sheet in which the agent will be disbursed.

The conductive coating 14 can have a thickness, shown as “t” in FIG. 1, that is, in various embodiments, 2 to 100 nanometers, 3 to 50 nanometers, 4 to 10 nanometers; or less than 100 nanometers, less than 50 nanometers, less than 25 nanometers, less than 12 nanometers, less than 10 nanometers, less than 8 nanometers, less than 6 nanometers, less than 4 nanometers, or less than 2 nanometers. In various embodiments of the present invention, the thickness of the conductive coating is less than the mean free path of electrons in the composition of the conductive coating, or less than 90% of that path, less than 70% of that path, less than 50% of that path, or less than 30% of that path. In various embodiments in which the agents of the present invention are used within a polymer sheet, the conductive coating can have the above-given thickness or less at the thickest point of the coating for at least 80%, 90%, 95%, 99%, or 100% of all of the individual particles in the polymer sheet. That is, in some embodiments, most or almost all of the particles will fall within the given range, and some will be larger than the given range.

The conductive coating can be formed on the dielectric core in any conventional manner that is known in the art, including, but not limited to, covalently binding gold nanoparticles to a dielectric core through an aminosilane group, then using these attached gold particles as seeds for further wet chemical growth of continuous gold shells around the dielectric core as described in U.S. Patent application U.S. 2001/0002275. As another example, gold shells can be grown on AuS₂ dielectric nanoparticles cores by methods described in Averitt et al., Phys. Rev. Lett., 78: 4217 (1997).

The dielectric core/conductive coating agents of the present invention will absorb infrared radiation without significantly absorbing visible light.

Specific examples of dielectric core/conductive coating agents of the present invention that can be disposed in polymer sheets include those described in Averitt et al., J. Opt. Soc. Am. B 16:1824 (1999); U.S. Patent Application 2001/0002275 A1; PCT application WO 99/46351; Graf and van Blaadern, Langmuir 18:524 (2002); Kawahashi and Shiho, Colloid Polym. Sci. 279:1231 (2001); and Odenburg et al., Chem. Phys. Let. 288:243 (1998). Information concerning coated particles can also be found in Westcott et al., Langmuir 14:5396 (1998) and Oldenburg et al., Ap. Phys. Lett. 75:1063 (1999).

Polymer Sheet

In various embodiments of the present invention, the infrared absorbing dielectric core/conductive coating agents of the present invention are disbursed within a polymer sheet. The concentration of the dielectric core/conductive coating agents in the sheet can be adjusted to suit the needs of the particular application. Generally, an amount of dielectric core/conductive coating agent will be added to the polymer sheet that is sufficient to impart the desired infrared absorbance on the sheet without also causing an unacceptable reduction in the transmission of visible light through the sheet. In various embodiments of the present invention, dielectric core/conductive coating agents are 10 to 300 parts per million (ppm by weight), 25 to 250 ppm, 20 to 200 ppm, 40 to 200 ppm, or 50 to 150 ppm of the polymer sheet.

In various embodiments, a polymer sheet of the present invention comprising the dielectric core/conductive coating agent absorbs at least 5%, at least 15%, at least 25%, at least 50%, at least 75%, or at least 90% of the infrared radiation between 700 nanometers and 2000 nanometers while transmitting at least 60%, at least 70%, at least 80%, at least 90%, or at least 95% of the visible light.

The polymer sheet of the present invention is generally useful as an interlayer in safety glass applications. The polymer sheet can comprise any suitable polymer, and, in a preferred embodiment, the polymer sheet comprises poly(vinyl butyral). In any of the embodiments of the present invention given herein that comprise poly(vinyl butyral) as the polymeric component of the polymer sheet, another embodiment is included in which the polymer component consists of or consists essentially of poly(vinyl butyral). In these embodiments, any of the variations in additives disclosed herein can be used with the polymer sheet having a polymer consisting of or consisting essentially of poly(vinyl butyral).

In one embodiment, the polymer sheet comprises a polymer based on partially acetalized poly(vinyl alcohol)s. In another embodiment, the polymer sheet comprises a polymer selected from the group consisting of poly(vinyl butyral), polyurethane, polyvinyl chloride, poly(ethylene vinyl acetate), combinations thereof, and the like. In one embodiment, the polymer sheet comprises poly(vinyl butyral). In other embodiments, the polymer sheet comprises plasticized poly(vinyl butyral). In further embodiments the polymer sheet comprises poly(vinyl butyral) and one or more other polymers. Other polymers having a suitable glass transition temperature can also be used. In any of the sections herein in which preferred ranges, values, and/or methods are given specifically for poly(vinyl butyral) (for example, and without limitation, for plasticizers, component percentages, thicknesses, and characteristic-enhancing additives), those ranges also apply, where applicable, to the other polymers and polymer blends disclosed herein as useful as components in polymer sheets.

For embodiments comprising poly(vinyl butyral), the poly(vinyl butyral) can be produced by known acetalization processes that involve reacting poly(vinyl alcohol) with butyraldehyde in the presence of an acid catalyst, followed by neutralization of the catalyst, separation, stabilization, and drying of the resin.

In various embodiments, the polymer sheet comprising poly(vinyl butyral) comprises 10 to 35 weight percent (wt. %) hydroxyl groups calculated as PVOH, 13 to 30 wt. % hydroxyl groups calculated as PVOH, or 15 to 22 wt. % hydroxyl groups calculated as PVOH. The polymer sheet can also comprise less than 15 wt. % residual ester groups, 13 wt. %, 11 wt. %, 9 wt. %, 7 wt. %, 5 wt. %, or less than 3 wt. % residual ester groups calculated as polyvinyl acetate, with the balance being an acetal, preferably butyraldehyde acetal, but optionally including other acetal groups in a minor amount, e.g., a 2-ethyl hexanal group (see, for example, U.S. Pat. No. 5,137,954).

In various embodiments, the polymer sheet comprises poly(vinyl butyral) having a molecular weight greater than 30,000, 40,000, 50,000, 55,000, 60,000, 65,000, 70,000, 120,000, 250,000, or 350,000 grams per mole (g/mole or Daltons). Small quantities of a dialdehyde or trialdehyde can also be added during the acetalization step to increase molecular weight to greater than 350 Daltons (see, for example, U.S. Pat. Nos. 4,874,814; 4,814,529; and 4,654,179). As used herein, the term “molecular weight” means the weight average molecular weight. Any suitable method can be used to produce the polymer sheets of the present invention. Details of suitable processes for making poly(vinyl butyral) are known to those skilled in the art (see, for example, U.S. Pat. Nos. 2,282,057 and 2,282,026). In one embodiment, the solvent method described in Vinyl Acetal Polymers, in Encyclopedia of Polymer Science & Technology, 3^{rd} edition, Volume 8, pages 381-399, by B. E. Wade (2003) can be used. In another embodiment, the aqueous method described therein can be used. Poly(vinyl butyral) is commercially available in various forms from, for example, Solutia Inc., St. Louis, Mo. as Butvar™ resin.

In various embodiments of polymer sheets of the present invention, the polymer sheets can comprise 20 to 60, 25 to 60, 20 to 80, or 10 to 70 parts plasticizer per one hundred parts of resin (phr). Of course other quantities can be used as is appropriate for the particular application. In some embodiments, the plasticizer has a hydrocarbon segment of fewer than 20, fewer than 15, fewer than 12, or fewer than 10 carbon atoms.

The amount of plasticizer can be adjusted to affect the glass transition temperature (T_{g}) of the poly(vinyl butyral) layer. In general, higher amounts of plasticizer are added to decrease the T_{g}. Poly(vinyl butyral) polymer sheets of the present invention can have a T_{g} of 40° C. or less, 35° C. or less, 30° C. or less, 25° C. or less, 20° C. or less, and 15° C. or less.

Any suitable plasticizers can be added to the polymer resins of the present invention in order to form the polymer sheets. Plasticizers used in the polymer sheets of the present invention can include esters of a polybasic acid or a polyhydric alcohol, among others. Suitable plasticizers include, for example, triethylene glycol di-(2-ethylbutyrate), triethylene glycol di-(2-ethylhexanoate), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, polymeric plasticizers such as the oil-modified sebacic alkyds, and mixtures of phosphates and adipates such as disclosed in U.S. Pat. No. 3,841,890 and adipates such as disclosed in U.S. Pat. No. 4,144,217, and mixtures and combinations of the foregoing. Other plasticizers that can be used are mixed adipates made from C₄ to C₉ alkyl alcohols and cyclo C₄ to C₁₀ alcohols, as disclosed in U.S. Pat. No. 5,013,779, and C₆ to C₈ adipate esters, such as hexyl adipate. In some embodiments, the plasticizer is triethylene glycol bis(2-ethylhexanoate).

Adhesion control agents can also be include in the polymer sheets of the present invention to impart the desired adhesiveness. For example, any of the ACAs disclosed in U.S. Pat. No. 5,728,472 can be used. Additionally, residual sodium acetate and/or potassium acetate can be adjusted by varying the amount of the associated hydroxide used in acid neutralization. In various embodiments, polymer sheets of the present invention comprise, in addition to sodium acetate, magnesium bis(2-ethyl butyrate)(chemical abstracts number 79992-76-0). The magnesium salt can be included in an amount effective to control adhesion of the polymer sheet to glass.

Additives may be incorporated into the polymer sheet to enhance its performance in a final product. Such additives include, but are not limited to, plasticizers, dyes, pigments, stabilizers (e.g., ultraviolet stabilizers), antioxidants, flame retardants, other IR absorbers, anti-block agents, combinations of the foregoing additives, and the like, as are known in the art.

Agents that selectively absorb light in the visible or near infrared spectrum can be added to any of the appropriate polymer sheets. Agents that can be used include dyes and pigments such as LaB6, indium tin oxide, antimony tin oxide, or lanthanum hexaboride.

The poly(vinyl butyral) polymer and plasticizer additives can be thermally processed and configured into sheet form according to methods known to those of ordinary skill in the art.

As used herein, “resin” refers to the polymeric (for example poly(vinyl butyral)) component that is removed from the mixture that results from the acid catalysis and subsequent neutralization of the polymeric precursors. Resin will generally have other components in addition to the polymer, for example poly(vinyl butyral), such as acetates, salts, and alcohols. As used herein, “melt” refers to a mixture of resin with a plasticizer and, optionally, other additives.

One exemplary method of forming a poly(vinyl butyral) layer comprises extruding molten poly(vinyl butyral) comprising resin, plasticizer, and additives and then forcing the melt through a sheet die (for example, a die having an opening that is substantially greater in one dimension than in a perpendicular dimension). Another exemplary method of forming a poly(vinyl butyral) layer comprises casting a melt from a die onto a roller, solidifying the resin, and subsequently removing the solidified resin as a sheet. In either embodiment, the surface texture at either or both sides of the layer may be controlled by adjusting the surfaces of the die opening or by providing texture at the roller surface. Other techniques for controlling the layer texture include varying parameters of the materials (for example, the water content of the resin and/or the plasticizer, the melt temperature, molecular weight distribution of the poly(vinyl butyral), or combinations of the foregoing parameters). Furthermore, the layer can be configured to include spaced projections that define a temporary surface irregularity to facilitate the de-airing of the layer during lamination processes after which the elevated temperatures and pressures of the laminating process cause the projections to melt into the layer, thereby resulting in a smooth finish. In various embodiments, the polymer sheets can have thicknesses of 0.1 to 2.5 millimeters, 0.2 to 2.0 millimeters, 0.25 to 1.75 millimeters, and 0.3 to 1.5 millimeters (mm).

The parameters for the polymer sheet described above apply as well to any layer in a multiple layer construct of the present invention that is a poly(vinyl butyral) type layer.

The dielectric core/conductive coating agents of the present invention can be readily added to the polymer sheet by mixing the dielectric core/conductive coating agents into the plasticizer and then melt blending with resin before formation of the layer product. In other embodiments, dielectric core/conductive coating agents can also be dispersed in a volatile solvent, combined with resin powder, and then melted and extruded. The high temperatures that occur during processing will cause the volatile solvent to evaporate, leaving the dielectric core/conductive coating agents dispersed in the polymer sheet.

The following paragraphs describe various techniques that can be used to improve and/or measure the characteristics of the polymer sheet.

The clarity of a polymer sheet, and particularly a poly(vinyl butyral) layer, can be determined by measuring the haze value, which is a quantification of the amount of light scattered away from the direction of the incident beam in passing through the layer. The percent haze can be measured according to the following technique. An apparatus for measuring the amount of haze, a Hazemeter, Model D25, which is available from Hunter Associates (Reston, Va.), can be used in accordance with ASTM D1003-61 (Re-approved 1977)-Procedure A, using Illuminant C, at an observer angle of 2 degrees. In various embodiments of the present invention, percent haze is less than 5%, less than 3%, and less than 1%.

The visible transmittance can be quantified using a UV-Vis-NIR spectrophotometer such as the Lambda 900 made by Perkin Elmer Corp. by methods described in international standard ISO 9050:1990.

Pummel adhesion can be measured according to the following technique, and where “pummel” is referred to herein to quantify adhesion of a polymer sheet to glass, the following technique is used to determine pummel. Two-ply glass laminate samples are prepared with standard autoclave lamination conditions. The laminates are cooled to about −17° C. (0° F.) and manually pummeled with a hammer to break the glass. All broken glass that is not adhered to the poly(vinyl butyral) layer is then removed, and the amount of glass left adhered to the poly(vinyl butyral) layer is visually compared with a set of standards. The standards correspond to a scale in which varying degrees of glass remain adhered to the poly(vinyl butyral) layer. In particular, at a pummel standard of zero, no glass is left adhered to the poly(vinyl butyral) layer. At a pummel standard of 10, 100% of the glass remains adhered to the poly(vinyl butyral) layer. Poly(vinyl butyral) layers of the present invention can have, for example, a pummel value of between 3 and 10.

The present invention includes multiple layer glass panels incorporating a polymer sheet of the present invention. In various embodiments, the multiple layer glass panels comprise a polymeric sheet of the present invention having distributed therein dielectric core/conductive coating agents, wherein the polymeric sheet is disposed between two panes of glass. In other embodiments, two or more polymer sheets are disposed against each other and the combination of polymer sheet layers is disposed between two glass panels. Other embodiments incorporate performance films, such as polyethylene terephthalate having reflective or absorbing layers, into multiple layer constructs. Other embodiments add one or more polymer sheets, polymer films, infrared reflecting films, acoustic energy absorbing sheets, and reinforcement films in any suitable combination.

The present invention includes an interlayer comprising a polyester type performance film disposed between two poly(vinyl butyral) layers, wherein one or both of the poly(vinyl butyral) layers is a poly(vinyl butyral) layer of the present invention comprising a dielectric core/conductive coating agent. The present invention also includes automotive windows and windshields and architectural glass panels incorporating any of the polymer sheet or interlayer constructs of the present invention.

Also included herein within the scope of the present invention are methods of blocking and/or reducing transmission of infrared and/or near infrared radiation through an opening, comprising the step of disposing in said opening any of the polymer sheet constructs of the present invention, for example, within a windshield or glass panel.

The present invention further includes a method of manufacturing a polymer sheet, comprising mixing any of the dielectric core/conductive coating agents of the present invention with any of the polymers given herein, and then forming a polymer sheet.

By virtue of the present invention, it is now possible to provide poly(vinyl butyral) sheet, and other polymer sheet, with superior, selective infrared transmission reduction characteristics.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

It will further be understood that any of the ranges, values, or characteristics given for any single component of the present invention can be used interchangeably with any ranges, values, or characteristics given for any of the other components of the invention, where compatible, to form an embodiment having defined values for each of the components, as given herein throughout. For example, a polymer sheet can be formed comprising sodium acetate in any of the ranges given in addition to any of the ranges given for plasticizer, where appropriate, to form many permutations that are within the scope of the present invention but that would be cumbersome to list.

Any figure reference numbers given within the abstract or any claims are for illustrative purposes only and should not be construed to limit the claimed invention to any one particular embodiment shown in any figure.

Figures are not drawn to scale unless otherwise indicated.

Each reference, including journal articles, patents, applications, and books, referred to herein is hereby incorporated by reference in its entirety.

1. A polymer interlayer comprising an infrared absorbing agent, wherein said agent comprises a dielectric core disposed within a conductive coating.

2. The interlayer of claim 1, wherein said interlayer comprises poly(vinyl butyral).

3. The interlayer of claim 2, wherein said interlayer comprises triethylene glycol bis(2-ethylhexanoate).

4. The interlayer of claim 1, wherein said dielectric core comprises a material selected from the group consisting of titanim dioxide, silica, colloidal silica, gold sulfide, polymethyl methacrylate and polystyrene.

5. The interlayer of claim 1, wherein said dielectric core comprises colloidal silica.

6. The interlayer of claim 1, wherein said conductive coating comprises a material selected from the group consisting of copper, silver, gold, platinum, palladium, iridium, nickel, antimony tin oxide, and indium tin oxide.

7. The interlayer of claim 1, wherein said conductive coating comprises a material selected from the group consisting of gold and silver.

8. The interlayer of claim 1, wherein said dielectric core comprises colloidal silica and said conductive coating comprises a material selected from the group consisting of gold and silver.

9. The interlayer of claim 1, wherein said dielectric core has an average diameter of less than 1,000 nanometers.

10. The interlayer of claim 1, wherein said dielectric core has an average diameter of less than 200 nanometers.

11. The interlayer of claim 1, wherein said conductive coating has a thickness of 2 nanometers to 100 nanometers.

12. The interlayer of claim 1, wherein said conductive coating has a thickness of 4 to 10 namometers.

13. The interlayer of claim 1, wherein said agent is present in said interlayer at a concentration of 20 to 200 ppm.

14. A multiple layer glass panel comprising a polymer interlayer comprising an infrared absorbing agent, wherein said agent comprises a dielectric core disposed within a conductive coating.

15. The multiple layer glass panel of claim 14, wherein said interlayer comprises polyvinyl butyral, polycarbonate, ethylene vinyl acetate, or polymethyl methacrylate.

16. The multiple layer glass panel of claim 14, wherein said interlayer comprises poly(vinyl butyral).

17. The multiple layer glass panel of claim 14, wherein said dielectric core comprises a material selected from the group consisting of titanim dioxide, silica, colloidal silica, gold sulfide, polymethyl methacrylate and polystyrene.

18. The multiple layer glass panel of claim 14, wherein said dielectric core comprises colloidal silica.

19. The multiple layer glass panel of claim 14, wherein said conductive coating a material selected from the group consisting of copper, silver, gold, platinum, palladium, iridium, nickel, antimony tin oxide, and indium tin oxide.

20. The multiple layer glass panel of claim 14, wherein said conductive coating comprises a material selected from the group consisting of gold and silver.

21. The multiple layer glass panel of claim 14, wherein said dielectric core comprises colloidal silica and said conductive coating comprises a material selected from the group consisting of gold and silver.

22. The multiple layer glass panel of claim 14, further comprising a first glass layer disposed in contact with said polymer interlayer and a second glass layer disposed in contact with said polymer sheet opposite said first glass layer.

23. The multiple layer glass panel of claim 14, further comprising one or more additional layers selected from the group consisting of glass layers, polymer sheets, polymer films, infrared reflecting films, acoustic energy absorbing sheets, and reinforcement films.

24. A method for reducing transmission of infrared radiation through an opening, comprising:
disposing in said opening a multiple layer glass panel comprising a polymer interlayer comprising an infrared absorbing agent, wherein said agent comprises a dielectric core disposed within a conductive coating.

25. The method of claim 24, wherein said interlayer comprises comprises polyvinyl butyral, polycarbonate, ethylene vinyl acetate, or polymethyl methacrylate.

26. The method of claim 24, wherein said interlayer comprises poly(vinyl butyral).

27. The method of claim 24, wherein said dielectric core comprises a material selected from the group consisting of titanim dioxide, silica, colloidal silica, gold sulfide, polymethyl methacrylate and polystyrene.

28. The method of claim 24, wherein said dielectric core comprises colloidal silica.

29. The method of claim 24, wherein said conductive coating comprises a material selected from the group consisting of copper, silver, gold, platinum, palladium, iridium, nickel, antimony tin oxide, and indium tin oxide.

30. The method of claim 24, wherein said conductive coating comprises a material selected from the group consisting of gold and silver.

31. The method of claim 24, wherein said dielectric core comprises colloidal silica and said conductive coating comprises a material selected from the group consisting of gold and silver.

32. The method of claim 24, further comprising a first glass layer disposed in contact with said polymer interlayer and a second glass layer disposed in contact with said polymer sheet opposite said first glass layer.

33. The method of claim 24, further comprising one or more additional layers selected from the group consisting of glass layers, polymer sheets, polymer films, infrared reflecting films, acoustic energy absorbing sheets, and reinforcement films.
